(19) United States
(12) Patent Application Publication
(10) Pub. No.: US 2010/0015474 A1
(43) Pub. Date: Jan. 21, 2010

(54) Adaptive Technique and Apparatus to Detect an Unhealthy Condition of a Fuel Cell System

(76) Inventors: Rebecca Dinan, Canandaigua, NY (US); Manikandan Ramani, Latham, NY (US)

Correspondence Address: TROP, PRUNER & HU, P.C., 1616 S. VOSS ROAD, SUITE 750, HOUSTON, TX, 77057-2631, US

(21) Appl. No.: 12/175,536

(22) Filed: Jul. 18, 2008

(51) Int. Cl. H01M 8/00

(52) U.S. Cl. 429/13; 429/12

(57) ABSTRACT

A technique that is usable with a fuel cell system having a fuel cell stack includes storing in a memory a healthy behavior pattern and an unhealthy behavior pattern for the fuel cell stack, comparing observed behavior of the fuel cell stack to the healthy and unhealthy behavior patterns, and classifying the observed behavior as healthy or unhealthy based on the comparison. The technique further includes modifying the stored healthy behavior pattern and the stored unhealthy behavior pattern based upon the occurrence of a predetermined event, such as the detection of an unhealthy condition, the issuance of an alarm, or the passage of a time interval. Modifying the behavior patterns enhances the accuracy of the health classification since the modification takes into account actual system behavior and any performance degradation that may occur over time.

### BACKGROUND

The invention generally relates to an adaptive technique and apparatus to detect an unhealthy condition of a fuel cell system.

A fuel cell is an electrochemical device that converts chemical energy directly into electrical energy. For example, one type of fuel cell includes a proton exchange membrane (PEM) that permits only protons to pass between an anode and a cathode of the fuel cell. Typically PEM fuel cells employ sulfonic-acid-based ionomers, such as Nafion, and operate in the 60° Celsius (C.) to 70° C. temperature range. Another type employs a phosphoric-acid-based polybenziamidazole, PBI, membrane that operates in the 150° C. to 200° C. temperature range. At the anode, diatomic hydrogen (a fuel) is reacted to produce hydrogen protons that pass through the PEM. The electrons produced by this reaction travel through circuitry that is external to the fuel cell to form an electrical current. At the cathode, oxygen is reduced and reacts with the hydrogen protons to form water. The anodic and cathodic reactions are described by the following equations:

H₂→2H⁺+2e⁻ at the anode of the cell, and Equation 1

O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) to provide more power.

The fuel cell stack may include flow plates (graphite composite or metal plates, as examples) that are stacked one on top of another, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

The fuel cell stack is one out of many components of a typical fuel cell system. For example, the fuel cell system may also include a cooling subsystem to regulate the temperature of the stack, a cell voltage monitoring subsystem, a control subsystem, a power conditioning subsystem to condition the power that is provided by the fuel cell stack for the system load, etc. The particular design of each of these subsystems is a function of the application that the fuel cell system serves.

During the course of its operation, the fuel cell stack may potentially experience one or more “unhealthy” conditions, such as flow channel flooding, membrane drying, fuel starvation, and carbon monoxide poisoning. Early detection of unhealthy conditions is important to trigger a recovery scheme to prevent the stack from further performance degradation to the point that the system has to be shut down. Also, accurate detection of an unhealthy condition is important to ensure that a recovery scheme or system shutdown is not activated unnecessarily. However, difficulties may arise in distinguishing an unhealthy condition from a healthy condition since system performance tends to degrade over time. Thus, parameters that may appear to reflect the presence of an unhealthy condition may, in actuality, simply be indicative of healthy performance of an aged system. In addition, each fuel cell system/fuel cell stack pair may exhibit different operating parameters and may degrade at different rates or in different manners over time. Accordingly, one set of health indicators that may indicate an unhealthy system for a particular fuel cell system/stack combination may actually represent a healthy system for a different combination.

Thus, there exists a continuing need for better ways to detect unhealthy conditions of a fuel cell system.

### SUMMARY

In an embodiment of the invention, a technique that is usable with a fuel cell system including a fuel cell stack comprises storing in a memory of the fuel cell system a healthy behavior pattern and an unhealthy behavior pattern for the fuel cell stack, observing behavior of the fuel cell stack, comparing the observed behavior to the healthy behavior pattern and the unhealthy behavior pattern, and classifying the observed behavior as healthy or unhealthy based on the comparison. The method further comprises modifying the stored healthy behavior pattern and the stored unhealthy behavior pattern based upon occurrence of a predetermined event.

In another embodiment of the invention, a fuel cell system includes a fuel cell stack, a memory to store a healthy behavior pattern and an unhealthy behavior pattern of the fuel cell stack, and a circuit to detect an unhealthy condition of the fuel cell stack based on a comparison of a current behavior pattern of the fuel cell stack with the healthy behavior pattern and the unhealthy behavior pattern. The circuit further is configured to modify the stored healthy and unhealthy behavior patterns based on occurrence of a predetermined event. Advantages and other features of the invention will become apparent from the following drawing, description and claims.

### BRIEF DESCRIPTION OF THE DRAWING

FIG. 1 is a schematic diagram of a fuel cell system according to an embodiment of the invention.

FIG. 2 is a graph showing a cell voltage distribution for a fuel cell stack when in a healthy condition, a cell voltage distribution for a fuel cell stack when in an unhealthy condition, and a current cell voltage distribution for the fuel cell stack, according to an embodiment of the invention.

FIG. 3 shows healthy and unhealthy confidence bands for a healthy cell distribution and an unhealthy cell distribution, according to an embodiment of the invention.

FIG. 4 is a flow diagram illustrating a technique to classify the health of a fuel cell system according to an embodiment of the invention.

FIG. 5 is a flow diagram of a technique to modifying stored behavior patterns that are used to classify the health of a fuel cell system according to an embodiment of the invention.

### DETAILED DESCRIPTION

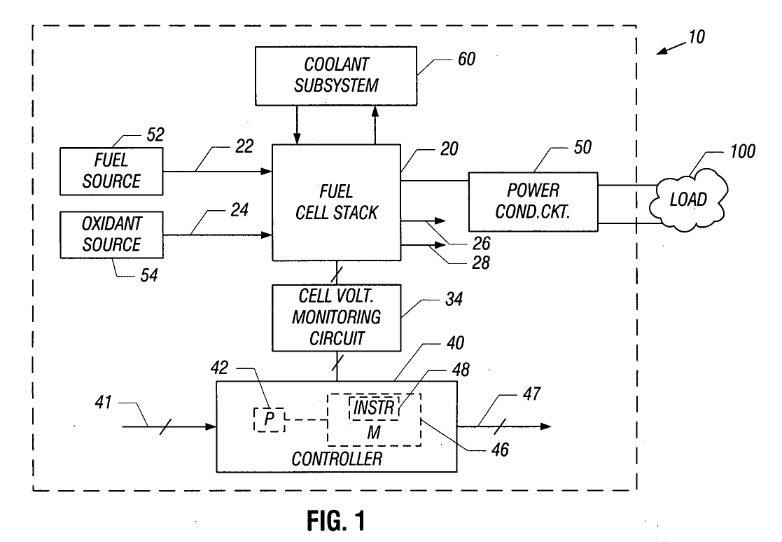

Referring to FIG. 1, in accordance with an embodiment of the invention, a fuel cell system 10 includes a fuel cell stack 20 (a PEM fuel cell stack, for example) that, in response to fuel and oxidant flows produces power for an electrical load 100. Power conditioning circuit 50 of the fuel cell stack converts a DC stack voltage of the fuel cell stack 20 into the appropriate voltage (DC or AC, depending on the type of load) for the load 100. For example, the load 100 may be a residential load and, may receive an AC voltage from the fuel cell system 10. However, in other embodiments of the invention, the fuel cell system 10 may provide a “DC” output voltage for the case where the load 100 is a DC load. Other variations are possible and are within the scope of the appended claims.

In accordance with embodiments of the invention, a fuel source 52 provides a fuel flow to the fuel cell stack 20 via an anode inlet 22. An oxidant source 54 provides an oxidant flow to a cathode inlet 24 of the fuel cell stack 20. The incoming oxidant flow to the fuel cell stack 20 passes through the oxidant flow channels of the fuel cell stack 20 to appear as cathode exhaust at a cathode outlet 28 of the stack 20; and the incoming fuel flow to the stack 20 passes through fuel flow channels of the fuel cell stack 20 to appear as anode exhaust at an anode outlet 26 of the stack 20.

Depending on the particular embodiment of the invention, the anode exhaust of the fuel cell stack 20 may be partially or totally recirculated; the anode exhaust may be partially or totally furnished to a flare or oxidizer; or alternatively, the anode chamber of the fuel cell stack 20 may be “dead-headed.” Additionally, depending on the particular embodiment of the invention, the cathode exhaust of the fuel cell stack 20 may be recirculated, may be furnished to a flare or oxidizer, etc. Thus, many variations are possible and are within the scope of the appended claims.

It is possible that during the course of the operation of the fuel cell system 10, fuel cell stack 20 may experience one or more unhealthy conditions that cause deteriorated performance of stack 20 and which may eventually result in damage to stack 20. These unhealthy conditions include, but are not limited to, carbon monoxide poisoning, fuel starvation, and flooding. Carbon monoxide poisoning occurs when an unacceptably high level of carbon monoxide is present in stack 20. Fuel starvation occurs when an unacceptably low amount of fuel is provided to stack 20. Flooding is a condition in which unacceptably high levels of condensed water are present in either the oxidant flow channels or the fuel flow channels of stack 20. Each of these unhealthy conditions may cause the stack 20 to cease functioning and eventually may result in permanent damage to the stack 20 if corrective action is not taken. Thus, it is important to detect an unhealthy condition of the stack early on to prevent the stack 20 from further performance degradation or being damaged to the point that the fuel cell system 10 has to be shut down.

Therefore, in accordance with embodiments of the invention, the fuel cell system 10 performs a technique to detect an unhealthy condition so that timely measures may be taken to recover the stack 20 to a healthy operating condition and thereby reduce the risk of stack damage and possibly avoid unexpected shutdowns of system 10. These measures may, for example, involve controlling the fuel source 52, the oxidant source 54, the power conditioning circuit 50, the coolant subsystem 60 or another component of the fuel cell system 10 until the unhealthy condition is corrected.

In accordance with embodiments of the invention described herein, the fuel cell system 10 monitors the stack's cell voltages to detect the unhealthy condition. The cell voltages are obtained via a cell voltage monitoring circuit 34, which is a circuit that regularly scans the cell voltages of the fuel cell stack 20 and communicates an indication of the scanned voltages to a controller 40 of the fuel cell system 10. An example of the cell voltage monitoring circuit 34 may be found in U.S. Pat. No. 6,140,820, entitled “Measuring Cell Voltages of a Fuel Cell Stack,” which issued on Oct. 31, 2000. Other embodiments of the cell voltage monitoring circuit 34 are possible and are within the scope of the appended claims.

As further described below, the controller 40 processes the cell voltages to derive behavior patterns that are indicative of healthy behavior and unhealthy behavior. The behavior patterns are stored in a memory 46 associated with the fuel cell system 10. In one embodiment, the memory 46 is located in the controller of the system 10. In other embodiments, the memory 46 may be attached to the stack 20. Using indicators obtained from these stored behavior patterns, the controller 40 is able to detect an unhealthy condition in any behavior observed while the system 10 is currently operating.

Unfortunately, detection of an unhealthy condition is not always easy. In some instances, the operating parameters of a system change over time as the system ages and performance degrades. In other instances, operating parameters that may be indicative of an unhealthy condition for a particular fuel cell stack/system combination may actually represent a healthy condition for another fuel cell stack/system pair. Accordingly, in some embodiments of the invention, the fuel cell system 10 is configured to detect an unhealthy condition in a manner that is tailored specifically for the particular system 10 and which adapts to take into account changes in system performance. Once the data and behavior patterns have been developed for a particular system 10/stack 20 pair, the data and behavior patterns may remain with that particular system 10/stack 20 combination.

More specifically, in accordance with some embodiments of the invention, a healthy behavior pattern 200 and an unhealthy behavior pattern 202 are developed for a particular system 10 having a particular fuel cell stack 20. The healthy and unhealthy behavior patterns 200, 202 may be developed from a set of operating parameters that are obtained during an initialization or training period of the system 10. For instance, the cell voltage monitoring circuit 34 may scan the cell voltages of the stack 20 while the system 10 is exhibiting known healthy behavior and while the system 10 is exhibiting known unhealthy behavior. Healthy and unhealthy behavior patterns may then be derived from the scanned cell voltages. Alternatively, generic healthy and unhealthy behavior patterns 200, 202 may be provided as a starting point for the system 10, and the patterns 200, 202 may then be adapted from data collected from the actual system 10/stack 20 combination when in operation to obtain new patterns 200a and 202a. Once the initial behavior patterns 200, 202 have been stored in memory 46 and the system 10 is placed in operation, the controller 40 generates a current behavior pattern 204 from currently observed behavior, such as from the cell voltages obtained by the cell voltage monitor circuit 34. The controller 40 may then compare the current behavior pattern 204 to the healthy and unhealthy patterns 200, 202 to determine the health of the system 10.

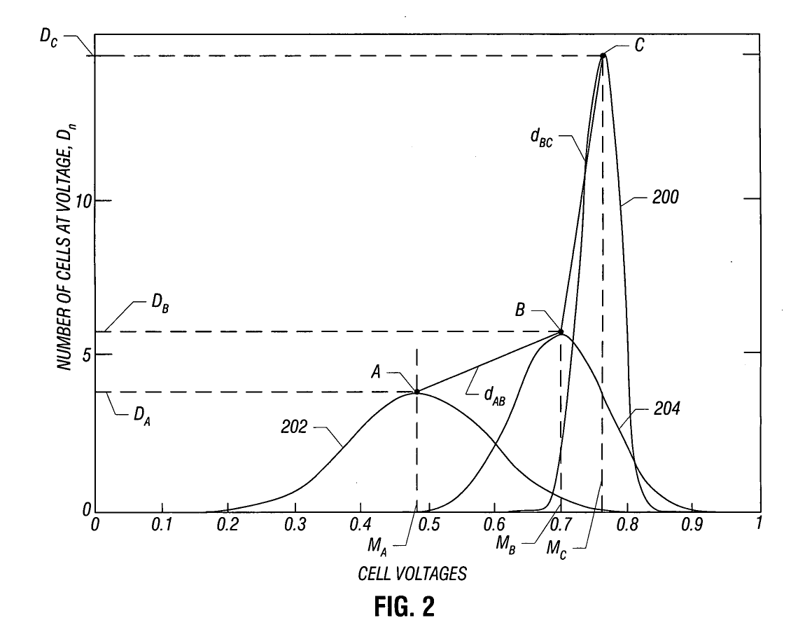

In some embodiments of the invention, the behavior patterns 200, 202, 204 that are derived from the cell voltage data are Gaussian distributions of cell voltages from which an average cell voltage and standard deviation may be determined. Exemplary healthy 200 and unhealthy 202 distributions are illustrated in FIG. 2. As can be seen in FIG. 2, the healthy distribution curve 200 is tall and narrow relative to the unhealthy distribution curve 202, which is short and wide. Accordingly, the shape of a cell voltage distribution curve may be an indicator that an unhealthy condition is present. For instance, if the shape of the distribution 204 of currently observed cell voltages obtained from the cell voltage monitor circuit 34 more closely resembles the shape of the unhealthy distribution 202, then the current behavior may be classified as unhealthy.

One method for determining whether the current distribution 204 more closely resembles the unhealthy distribution 202 is to determine the Euclidean distance between the healthy and unhealthy distribution curves 200, 202, as illustrated in FIG. 2. Referring to FIG. 2, the healthy 200, unhealthy 202 and current 204 distribution curves are plotted on a graph having a vertical axis representing the number of cells at a particular voltage (Dₙ), and a horizontal axis representing the mean cell voltage (Mₙ). As can be seen in FIG. 2, the current distribution 204 lies between and overlaps both the healthy 200 and unhealthy 202 distributions. To determine whether the current distribution 204 more closely resembles the unhealthy distribution 202, the distance between points A (which represents the number of cells at the mean cell voltage of the unhealthy curve 202) and B (which represents the number of cells at the mean cell voltage of the current curve 204) and the distance between points B and C (which represents the number of cells at the mean cell voltage of the healthy curve 200) may be calculated as follows:

d_{AB}=\sqrt{(M_{B}−M_{A})²+(D_{B}−D_{A})²} Equation 3

d_{BC}=\sqrt{(M_{C}−M_{B})+(D_{C}−D_{B})²} Equation 4

If the distance between A and B is less than the distance between points B and C, then the current distribution 204 can be deemed to more closely resemble the unhealthy distribution 202. If not, then the current distribution 204 can be deemed to more closely resemble the healthy distribution 200, and the current behavior may be classified as healthy. However, if the distances are the same or substantially the same (e.g., within a range of ±10%, for instance), then the classification of the behavior may not be made with a high degree of confidence. In such a case, and in accordance with some embodiments of the invention, the confidence of the classification of the behavior may be increased by examining another indicator, as will be explained in further detail below.

Other indicators that may be examined are the average (i.e., mean) cell voltage and a standard deviation, σ, of each of the cell voltage distributions. For instance, if the magnitudes of the currently observed average cell voltage and standard deviation are similar to the average cell voltage and standard deviation of the unhealthy distribution 202, then the current behavior may be classified as unhealthy.

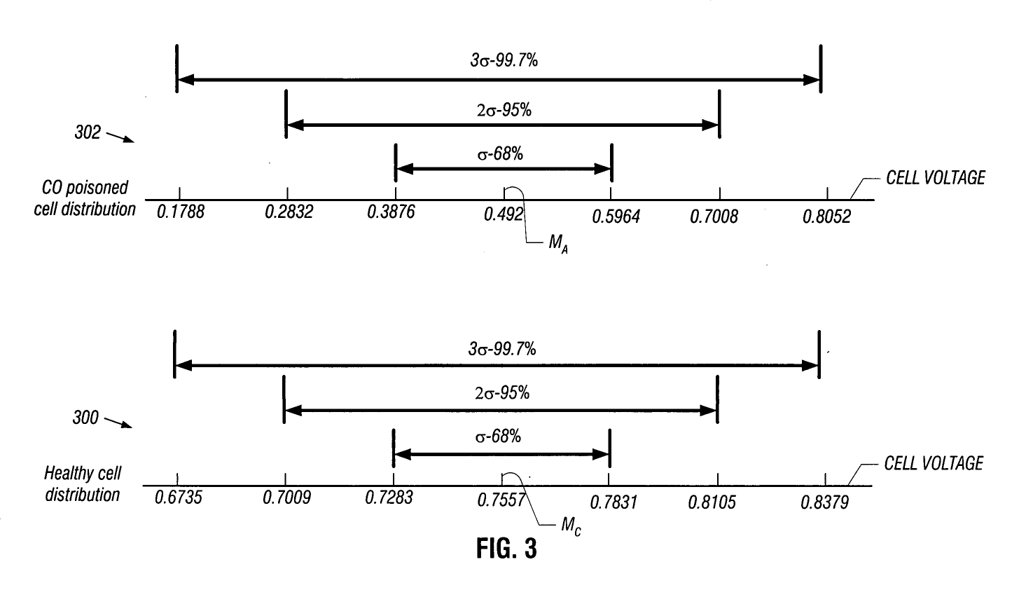

In some embodiments, rather than simply comparing magnitudes, the comparison between the observed average cell voltage and standard deviation, σ, with those of the healthy and unhealthy distributions may be performed by developing confidence bands 300, 302 for each of the healthy and unhealthy distributions, as shown in FIG. 3. For each distribution, the 1σ confidence band represents a 68% confidence level, the 2σ represents a 95% confidence level, and the 3σ represents a 99.7% confidence level. Thus, for instance, if the observed average cell voltage, M_{B}, falls within the 2σ confidence band for the healthy distribution 200, then there is a 95% confidence level that the observed behavior is healthy.

As can be seen in FIG. 3, however, the confidence bands 300, 302 for the healthy and unhealthy distributions may overlap. Thus, an observed average cell voltage, M_{B}, may fall within a confidence band for both distributions. For instance, in FIG. 3, an observed average cell voltage of 0.7 v falls within both the 95% confidence band for the unhealthy distribution 202 and the 99.7% confidence band for the healthy distribution 200. While it might seem that the behavior should be classified as healthy, the 99.7% and 95% confidence levels are relatively close. Thus, in many instances, it may be desirable to again examine other indicators to increase the confidence in the classification of the observed behavior as unhealthy.

Yet another indicator that may be derived from the healthy and unhealthy patterns is a signal-to-noise (SNR) ratio. The SNR represents the manner in which the average cell voltage, M, and the standard deviation, σ, are changing and is calculated as follows:

$$S N R = 20 log ( \frac{{M}_{n}}{{σ}_{n}} ) \qquad Equation 5$$

Thus, for example, a distribution having an average cell voltage of 0.7V and a standard deviation of 0.07 would yield an SNR of 20. Generally, an SNR that is above 30 is indicative that the system is healthy, and an SNR that is below 20 may indicate the presence of an unhealthy condition. Thus, while the SNR may not be an absolute indicator of the health of a system, it may be useful when used in combination with other indicators to increase the confidence in the classification of the behavior of a particular system as unhealthy.

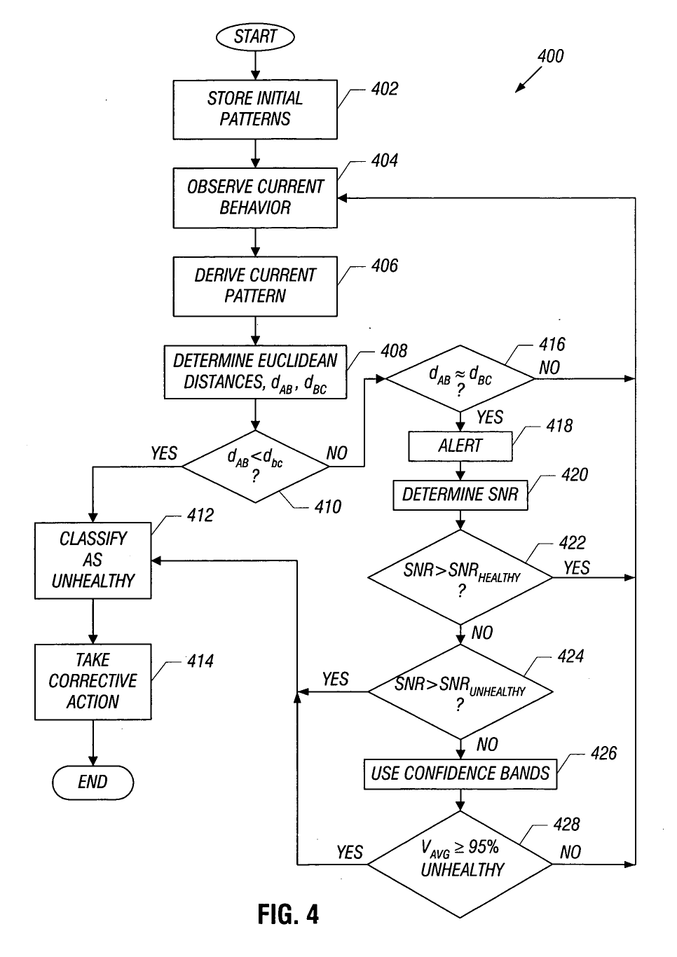

An exemplary method 400 for classifying the current behavior of the system as healthy or unhealthy using one or more of the indicators discussed above is illustrated in FIG. 4. When the particular fuel cell system 10/stack 20 pair is initially combined and placed into operation, a healthy behavior pattern 200 and an unhealthy behavior pattern 202 are provided and stored in the memory 46 of the controller 40 and any previous patterns that may be stored in the memory 46 are replaced (block 402). In some embodiments of the invention, the healthy behavior pattern 200 is a distribution of cell voltages that are present when the system 10 is in a known healthy operating condition, and the unhealthy behavior pattern 202 is a distribution of cell voltages that are exhibited when various known levels of carbon monoxide poisoning (i.e., an unhealthy condition) are present. The cell voltages for each of these operating conditions may be collected during an initialization or training period for the particular system 10/pair 20 combination.

During operation, the behavior of the system 10 is observed by monitoring, for instance, the cell voltages of the fuel cell stack 20 (block 404). A distribution 204 of current cell voltages is then derived from the monitored voltages (block 406) and compared to the stored healthy and unhealthy cell voltage distributions 200 and 202. In some embodiments, the distribution 204 of current cell voltages may be derived in a continuous manner, or the voltages may be collected and the distribution 204 generated at predefined intervals.

The comparison of the current distribution 204 to the healthy and unhealthy distributions 200, 202 may be performed by comparing the distributions themselves and/or indicators derived from the distributions. For instance, in block 408, the current distribution 204 is compared to the healthy and unhealthy distributions 200, 202 by determining the Euclidean distance between distributions. If the Euclidean distance d_{AB} between the current distribution 204 and the unhealthy distribution 202 is less than the distance d_{BC} between the current 204 and healthy distributions 200 (diamond 410), then the current behavior may be classified as unhealthy (block 414) and corrective action may be taken, including issuing an alert or warning or shutting down the system. If the distance d_{AB} between the current 204 and unhealthy 202 distributions is not less than the distance d_{BC} between the current 204 and healthy 200 distributions and the distances are not substantially equal (diamond 416), then the current behavior is deemed healthy and monitoring of the current behavior continues. However, if the distances are substantially the same, then a health classification can not be made with any confidence, and another indicator should be examined. At this point, and in some embodiments, a warning or alert also may be issued to inform an operator of the system of a potential problem (block 418).

If the decision is made to examine another indicator, then, in some embodiments, the SNR corresponding to the current distribution 204 may be determined (block 420). The SNR may either be compared to the SNRs for the healthy and unhealthy distributions 200, 202 or to a threshold value, or a determination may be made as to whether the current SNR falls within either a healthy or unhealthy range or within a range between healthy and unhealthy SNRs. For instance, if the current SNR indicates that the behavior may be deemed healthy (e.g., SNR is greater than 30) (diamond 422), then behavior monitoring continues. If the current SNR indicates that the behavior may be unhealthy (e.g., SNR is less than 20) (diamond 424), then an unhealthy classification may be made and corrective action taken. However, if the current SNR falls between a healthy and unhealthy indication, then yet another indicator may be examined to further increase the confidence in the behavior classification. In such a case, and in some embodiments, an alert or warning also may be issued.

In embodiments in which another indicator is examined, that indicator may be, for example, the average cell voltage, M, and the standard deviation, σ (block 426). In the method illustrated in FIG. 4, 1σ, 2σ and 3σ confidence bands 300, 302 are developed for each of the healthy and unhealthy distributions 200, 202. The location of the current average cell voltage, M_{B}, within each of the confidence bands is then determined. The behavior of the system is then classified based on its location within the confidence bands. In one embodiment, if the current average cell voltage, M_{B}, falls within the 2σ or higher unhealthy confidence band 302 (diamond 428), then the behavior is classified as unhealthy regardless of the location within the healthy confidence band 300. If not, then the system 10 may be deemed healthy and monitoring continues. In other embodiments, the behavior may be classified based on the location having the highest confidence level.

Once the behavior has been classified as unhealthy, various types of corrective action may be taken. In addition, other system parameters (e.g., temperatures of various components or subsystems, fuel flow, etc.) may be examined to determine the source of the unhealthy behavior and the appropriate corrective action. An exemplary method for identifying and implementing the most appropriate corrective action is disclosed in pending application Ser. No. 11/645,244, filed Dec. 22, 2006, entitled “Technique and Apparatus to Detect and Recovery from an Unhealthy Condition of a Fuel Cell Stack,” which is hereby incorporated by reference in its entirety.

It should be understood that additional, fewer, or alternative steps may be included in the method illustrated in FIG. 4. In addition, it is contemplated that the steps of the illustrated method may be performed in an order other than that illustrated. For instance, in some embodiments, the confidence bands and the SNR may be examined before the distributions are compared, examination of other health indicators may also be included, or all indicators may be examined before the behavior can be classified as unhealthy.

In addition to providing a plurality of indicators to increase the confidence in the classification, the health classification technique 400 disclosed herein may also be adapted over time to take into account aging and performance degradation of the system. By adapting the health indicators, the confidence in the health classification may be further enhanced.

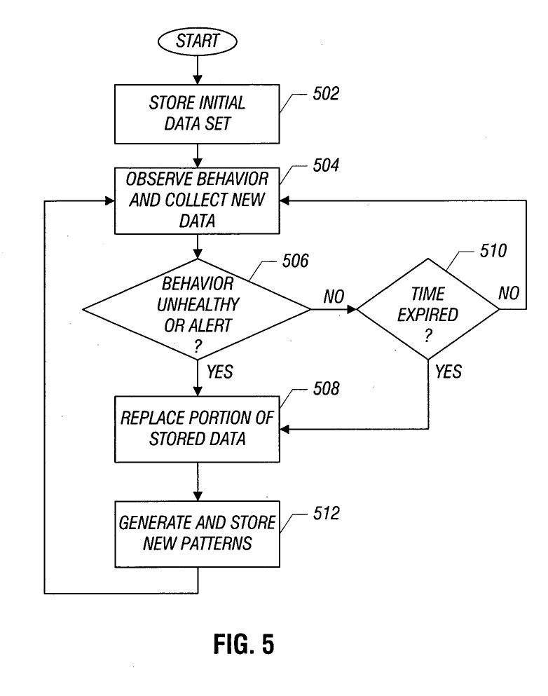

In some embodiments of the invention, and with reference to FIG. 5, the technique 400 is adapted by modifying the initial healthy and unhealthy behavior patterns 200, 202 stored in the memory 46 (block 502) of the controller 40 as more data is collected from the system 10 (block 504). The behavior patterns 200, 202 may be modified randomly, continuously or in response to the occurrence of a particular event, including detection of a particular type of observed behavior, expiration of a time interval, etc. In some embodiments, the patterns 200, 202 are modified by replacing a portion of the data set used to derive the patterns with new data that has been collected during operation. For instance, when an unhealthy condition has been detected or an alert has been issued (diamond 506), the cell voltages that had been observed in a time period (e.g., 5 minutes, 1 hour, etc.) immediately preceding the event may be used to replace an equal amount of the data that had been used to create the existing, stored healthy and unhealthy behavior patterns (block 508). Thus, for example, the last five minutes of current data may be used to replace the oldest five minutes of data underlying the stored patterns 200, 202. In other embodiments, the patterns 200, 202 may be modified or adapted on a periodic basis, such as once a month, and/or a substantial portion of the data may be replaced with the new data. In yet other embodiments, the patterns 200, 202 may be modified based on the observed behavior of the system 10 (e.g., based on detection of an unhealthy condition, based on issuance of an alarm, etc.) as well as on a periodic basis (diamonds 506 and 510).

New or modified healthy and unhealthy behavior patterns 200a, 202a then may be generated based on the modified data set (block 512). In embodiments in which the pattern is a Gaussian distribution, the patterns 200a, 202a may be generated using an algorithm that separates or clusters the data in the data set into the appropriate number of groups, such as a healthy group and an unhealthy group. An exemplary algorithm to perform this task is the known “K-means clustering” algorithm. As is known in the art, the K-means clustering algorithm is aware that there are “k” groups within a data set and then works to cluster the data into the “k” groups. After clustering the data, the algorithm also solves for the average or mean and the standard deviation for each group. Other types of grouping or clustering algorithms also may be used to generate the healthy and unhealthy behavior patterns or distributions. The new patterns 200a, 202a then replace the old patterns 200, 202 that were stored in memory 46. The new patterns 200a, 202a may then be used to classify the behavior of the system as healthy or unhealthy as described above.

The classification and pattern modification techniques illustrated in FIGS. 4 and 5 may be performed by the system 10 illustrated in FIG. 1. With reference to FIG. 1, and in accordance with some embodiments of the invention, the controller 40 includes a processor 42 (one or more microprocessors and/or microcontrollers, as example) that is coupled to the memory 46 that may, for example, store program instructions 48 to cause the controller 40 to operate as described herein to develop behavior patterns and analyze observed behavior for purposes of detecting unhealthy conditions. As also depicted in FIG. 1, the controller 40 may include various input terminals 41 for purposes of receiving status signals, signals indicative of commands, etc. and the controller 40 may include output terminals 47 for purposes of controlling various aspects of the fuel cell system 10, such as controlling motors, valves, communicating messages, generating alarm conditions, etc., depending on the particular embodiment of the invention.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method usable with a fuel cell system having a fuel cell stack, comprising:
storing in a memory of the fuel cell system a healthy behavior pattern and an unhealthy behavior pattern for the fuel cell stack;
observing behavior of the fuel cell stack;
comparing the observed behavior to the healthy behavior pattern and the unhealthy behavior pattern;
classifying the observed behavior as healthy or unhealthy based on the comparison; and
modifying the stored healthy behavior pattern and the stored unhealthy behavior pattern based at least upon the observed behavior.

2. The method of claim 1, wherein the stored healthy and unhealthy behavior patterns are modified if the observed behavior is classified as unhealthy.

3. The method of claim 1, wherein the stored healthy and unhealthy behavior patterns are modified upon expiration of a time period.

4. The method of claim 1, wherein the healthy behavior pattern comprises a healthy distribution of healthy cell voltages associated with the fuel cell stack, and wherein the unhealthy behavior pattern comprises an unhealthy distribution of unhealthy cell voltages associated with the fuel cell stack, and the method further comprises determining a current distribution of cell voltages associated with the fuel cell stack from the observed behavior.

5. The method of claim 4, wherein classifying the observed behavior comprises:
comparing the current distribution to the healthy and unhealthy distributions.

6. The method of claim 5, wherein the act of comparing comprises determining a Euclidean distance between the current and healthy distributions and a Euclidean distance between the current and unhealthy distributions.

7. The method of claim 6, wherein classifying the observed behavior further comprises:
determining a signal-to-noise ratio for the current distribution.

8. The method of claim 7, wherein classifying the observed behavior further comprises:
determining an unhealthy confidence band based on the standard deviation of the unhealthy distribution; and
classifying the observed behavior as unhealthy based on the location within the unhealthy confidence bands of the average cell voltage of the current distribution.

9. The method of claim 1, wherein the healthy and unhealthy patterns comprise a first set of cell voltages, and wherein modifying comprises:
generating a modified set of cell voltages by replacing a portion of the first set of cell voltages with a portion of the observed current cell voltages; and
deriving a new healthy pattern and a new unhealthy pattern from the modified set.

10. The method of claim 9, wherein deriving the new patterns comprises clustering the cell voltages in the modified set into a plurality of groups, wherein a first group represents a modified healthy cell distribution and a second group represents a modified unhealthy cell distribution.

11. The method of claim 1, further comprising replacing the stored healthy and unhealthy behavior patterns if the fuel cell stack is used in a different fuel cell system.

12. A fuel cell system comprising:
a fuel cell stack;
a memory to store a healthy behavior pattern and an unhealthy behavior pattern of the fuel cell stack; and
a circuit to detect an unhealthy condition of the fuel cell stack based on a comparison of a current behavior pattern of the fuel cell stack with the healthy behavior pattern and the unhealthy behavior pattern and to modify the stored healthy and unhealthy behavior patterns based on the current behavior pattern.

13. The fuel cell system of claim 12, wherein the circuit comprises:
a monitoring circuit to observe current behavior of the fuel cell stack; and
a controller to receive an indication of the current behavior from the monitoring circuit, derive the current behavior pattern, detect the unhealthy condition, and modify stored healthy and unhealthy behavior patterns.

14. The fuel cell system of claim 13, wherein the memory stores program instructions and the controller executes the instructions to modify the stored behavior patterns.

15. The fuel cell system of claim 13, wherein the stored healthy behavior pattern is a distribution of healthy cell voltages of the fuel cell stack and the stored unhealthy behavior pattern is a distribution of unhealthy cell voltages of the fuel cell stack, and wherein the controller is configured to derive the current behavior pattern based on a current distribution of currently observed cell voltages of the fuel cell stack.

16. The fuel cell system of claim 15, wherein the controller detects the unhealthy condition based upon a plurality of indicators derived from the healthy, unhealthy and current behavior patterns.

17. The fuel cell system of claim 16, wherein the plurality of indicators comprise a standard deviation and an average cell voltage.

18. The fuel cell system of claim 13, wherein the controller generates modified behavior by replacing at least a portion of the stored behavior with at least a portion of currently observed behavior, and wherein the controller modifies the stored healthy and unhealthy behavior patterns using the modified behavior.

19. The fuel cell system of claim 18, wherein the controller executes a k-means clustering algorithm to generate the modified healthy and unhealthy behavior patterns from the modified behavior.

20. The fuel cell system of claim 13, wherein the controller modifies the stored healthy and unhealthy behavior patterns based on detection of an unhealthy condition.

21. The fuel cell system of claim 13, wherein the controller modifies the stored healthy and unhealthy behavior patterns based on expiration of a time period.
